(19) United States
(12) Patent Application Publication
(10) Pub. No.: US 2022/0078502 A1
(43) Pub. Date: Mar. 10, 2022

(54) TECHNIQUES FOR OBTAINING AND DISTRIBUTING USER-GENERATED CONTENT TO INTERNET-BASED CONTENT PROVIDERS

(71) Applicant: Burst, Inc., Boston, MA (US)

(72) Inventor: Jayachandran Ramadorai, Newton, MA (US)

(21) Appl. No.: 17/316,598

(22) Filed: May 10, 2021

Related U.S. Application Data
(63) Continuation of application No. 16/280,893, filed on Feb. 20, 2019, now abandoned.
(60) Provisional application No. 62/632,977, filed on Feb. 20, 2018.

(51) Int. Cl. H04N 21/2743; G06F 16/955; H04N 21/2343; H04N 21/472; H04N 21/462

(52) U.S. Cl. CPC H04N 21/2743; G06F 16/9554; H04N 21/4622; H04N 21/47202; H04N 21/2343

(57) ABSTRACT

Techniques are disclosed for a network-based content distribution and communication system enabling the efficient capture and communication of user generated content (UGC) to an over-the-top (OTT) content provider. The system can facilitate distribution of the UGC to OTT content providers to enable display of the UGC with the OTT content to which it relates. The system enables a user (e.g., a viewer of OTT content) to engage with presentation of content by providing an interface that enables the user to communicate UGC from the user's device, in real-time, to a provider of OTT content. In turn, an OTT content provider can incorporate the UGC into OTT content, in real-time during the presentation of the OTT content. The UGC may be presented to other users who are viewing the program at the same time, thereby enabling users to communicate with each other by sharing UGC.

### CROSS-REFERENCES TO RELATED APPLICATIONS

This application is a continuation of U.S. application Ser. No. 16/280,893, filed Feb. 20, 2019, which claims the benefit of U.S. Provisional Application No. 62/632,977, filed on Feb. 20, 2018, the disclosures of which are hereby incorporated in their entirety.

### BACKGROUND

The present disclosure relates generally to processing, acquiring, and distribution of media content.

Many broadcast systems developed before the Internet use specialized technology. A typical example is producing live telecasts of sporting events. With the development of the Internet, content providers distribute media content (e.g., audio, video, and other media) via the Internet without utilizing a broadcast system or service provider, such as an operator of multiple cable or direct-broadcast satellite television systems (so-called multiple-system operators, or “MSOs”) controlling or distributing the content. Distribution of such media content via the Internet without utilizing a broadcast system is referred to by some as over-the-top (OTT) content. Examples of OTT content providers include YouTube®, Hulu®, Amazon®, and Netflix®. Such providers may distribute content through media devices, among many others, such as Roku®, Apple TV®, Xbox®, and Chromecast®. Providers of Internet service enabling content providers to distribution of OTT content via the Internet may be aware of the contents of the Internet Protocol (IP) packets for transmission of the content, but are not responsible for, nor able to control, the viewing abilities, copyrights, and/or other redistribution of the content.

With the rise of social media, users desire to communicate and share information related to content that they watch. Often times, users may want to share content with others to supplement content they are viewing by an OTT content provider. Such content may be referred to as “user-generated content” (UGC) or as user-created content (UCC), representing any form of content including posts, chats, tweets, podcasts, digital images, video, audio files, advertisements and other forms of media. Viewers of OTT content who wish to participate in communication via social media channels are challenged with ways to share UGC with other users. For many users having a mobile device, the users are able to easily capture content, but are not able to share such content, in real-time, with other users who happen to be accessing the same OTT content. OTT providers may be challenged with aggregating UGC from users who are viewing OTT content.

### BRIEF SUMMARY

Techniques are disclosed for obtaining and distributing user-generated content (UGC) to content providers. UGC may include, for example, audio, video, or images. In particular, a network-based content distribution and communication system is disclosed for efficient capture and communication of UGC to an OTT provider. The system can facilitate distribution of the UGC to OTT content providers to enable display of the UGC related to the OTT content. The system enables a user (e.g., a viewer of OTT content) to engage with presentation of content by providing an interface that enables the user to communicate UGC from the user's device, in real-time, to a provider of OTT content. In turn, an OTT content provider can incorporate the UGC into OTT content, in real-time during the presentation of the OTT content. The UGC may be presented to other users who are viewing the program at the same time, thereby enabling users to communicate with each other by sharing UGC.

A content distribution and communication system (also referred to as “content system”) can facilitate receiving UGC from a user's device (e.g., a client device) operated by a user. A client device can include a mobile phone or a desktop computer. A user may operate his/her client device to capture and/or produce UGC. The UGC may be related to or acquired during presentation of content by an OTT provider. A client device operated by a user may be different from a device (e.g., a media device) enabling the presentation of OTT content by the OTT provider. A user may desire to share the UGC with the OTT provider and/or other users who are viewing the presentation by the OTT provider. The system may provide a mechanism, such as a graphical user interface (GUI), whereby the user can access and choose UGC content stored on the client device for communication to the OTT provider. In some embodiments, the system may provide a GUI at the client device that enables the presentation of the OTT content. The GUI may be interactive to enable the user to request and/or to share UGC content with the OTT provider.

The content system can manage, curate, and distribute UGC content. UGC content from a client device can be uploaded to the content system using a variety of techniques. In one embodiment, a GUI can be provided on the client device to enable the user to select UGC content for upload from the client device. The GUI may be in an application (e.g., a web browser) that is configured to communicate with or provided by the content system. In some embodiments, the GUI may be provided by the content system. Using the GUI, the user can provide input indicating an OTT provider and/or a specific program for which to associate the UGC. The content system may provide a mechanism by which the user can select a specific data storage container (e.g., a bubble) to provide UGC for a particular OTT provider and/or program. The container may be configured by a user, such as an operator of an OTT provider, for curation and management of UGC content. A GUI on the client device may provide options to specify the location (e.g., bubble) for uploading UGC. The GUI may be interactive to enable the user to submit information about the UGC, including, but not limited to, a comment, a title, a name, a social media address, or other metadata descriptive of the UGC.

In some embodiments, the content system may facilitate communication between the device of a user and the system of an OTT content provider for obtaining UGC content from the user. For example, a user may interact with a GUI on a device presenting a program by an OTT provider. The GUI may enable a user to specify the destination for providing UGC content, such as a container associated with content for a program or the OTT provider directly. The GUI may enable the user to initiate a process that involves communication by the media device or the OTT provider to the content system to initiate a request for UGC from the client device. The content system may initiate a process that presents a graphical interface on the client device prompting the user to specify UGC content to be uploaded to the content system. The content system can communicate the UGC content to the OTT provider to make the UGC content available in a GUI of the OTT. The UGC content may be presented with a program to which the UGC content relates.

In some embodiments, the content system may facilitate minimal, or no user involvement for configuration of an application for uploading UGC to the content system. Such a process may be referred to herein as app-less uploading. The content system may provide a GUI (e.g., a web browser) on a client device may be presented to upload UGC in response to interaction with an application accessed on the client device or another device, such as a media device presenting a program by an OTT provider. The application may provide information that enables the client device to render access to a location, e.g., a URL, of a container where UGC content may be uploaded. As a result of accessing the URL, the GUI is presented to upload UGC. In one example, the URL may be accessed in response to a user operating a camera of the client device to capture an image (e.g., a QR code) that is configured with information (e.g., a URL for a container). The client device may be configured to process the image upon capture, which causes the URL to be accessed in an application, such as a web browser, which displays the graphical interface to upload UGC to a container. In other examples, a URL for the container may be accessed in an application (e.g., a social media application), a website (e.g., a social media website or a website of an OTT provider), an SMS message, or other application made available to a user. Some of the disclosed techniques enable a user to provide UGC content in real-time from a client device to an OTT provider, without having to download or configure an application on the client device to access the UGC content. A user can operate any device storing UGC and communicate with different OTT providers, without configuring either of the client device of the user and the system of the OTT provider to enable communication of the UGC. The techniques further enable UGC to be communicated to an OTT provider via the content system without causing the UGC to be accessed or stored by any system, such as a system supporting a third party site through which the URL was accessed.

A data storage container for receiving UGC may be created in the content system by an OTT provider. The container may be associated with a location, such as a URL. The URL may be accessible externally to the content system as a direct location where UGC can be uploaded. The URL may be configured by content system such that an application that accesses the URL receive content to render a GUI that is interactive to enable a user to upload UGC from the client device. The URL may be provided by the content system to the client device or may be provided by OTT provider system after receiving it from the content system.

The content system may be provide a GUI that enables an OTT provider to manage, curate, and approve UGC in one or more containers. The GUI may be provided in an application (e.g., a web browser). The GUI may enable different users to access the UGC with respect to their roles and the privileges assigned to those roles. The GUI may enable a user that provided the UGC to view the UGC or specify one or more attributes with the UGC. A user of an OTT provider may be a content producer who can use the GUI to view the UGC as it's uploaded to a container and make decisions on which UGC to approve, when and where to distribute the UGC. UGC may be provided using other techniques such as a through an application on a device or a website.

In at least one embodiment, the content system may provide a programming interface, such as an application programming interface (API) that enables communication of media to and from the content system. The API may be used by an application on a client device and systems of OTT providers to communicate UGC. In some embodiments, the program code supporting the API may be configured for the content system to determine how to communicate UGC to and from the content system. Specifically, when uploading UGC from a client device, and downloading UGC to an OTT provider system, the content system can consider many attributes about the UGC and the devices with which the content system is communicating. Examples of attributes about UGC include a format of the UGC, a size of the UGC, a compression factor of the UGC etc. Examples of attributes about devices may include the protocol for communication supported by the devices, the number of connections to the devices, the type of devices, the model of the devices, etc.

Some embodiments may be implemented by a computer system that is configured to implement methods and operations disclosed herein. Yet some embodiments relate to systems, computer products, and machine-readable tangible storage media, which employ or store instructions for methods and operations disclosed herein. In at least one embodiment, systems may include one or more processors and memory. The memory may store instructions that are executable by the one or more processors to perform methods and operations disclosed herein. Systems may include a computer product, machine-readable tangible storage media, modules, or a combination thereof to perform methods and operations disclosed herein.

The foregoing, together with other features and embodiments will become more apparent upon referring to the following specification, claims, and accompanying drawings.

### BRIEF DESCRIPTION OF THE DRAWINGS

FIG. 1 shows a block diagram of a user generated content (UGC) submission system according to an embodiment.

FIG. 2 is a block diagram illustrating content curation and distribution according to an embodiment.

FIG. 3 is a block diagram illustrating a bubble and widget architecture according to an embodiment.

FIG. 4 is a diagram of a subset of data structures implemented in an embodiment.

FIG. 5 is a diagram of a graphical user interface for an individual to create a bubble according to an embodiment.

FIG. 6 is a diagram of a graphical user interface for UGC settings for a bubble according to an embodiment.

FIG. 7 is a diagram of a graphical user interface for announcing a bubble on Twitter, and receiving the announcement, according to an embodiment.

FIGS. 8A-B are diagrams of a graphical user interface for submitting media to a bubble according to an embodiment.

FIG. 9 is a diagram of additional elements of a graphical user interface for submitting media to a bubble according to an embodiment.

FIG. 10 is a diagram illustrating the addition of a WOW tag to UGC media according to an embodiment.

FIG. 11 is a diagram illustrating multiple bubbles according to an embodiment.

FIG. 12 is a diagram illustrating the management of media in a bubble according to an embodiment.

FIGS. 13A-B are diagrams illustrating a bubble and information about media in the bubble according to an embodiment.

FIG. 14 is a simplified block diagram of a representative computing system and client computing system usable to implement certain embodiments.

FIGS. 15-17 illustrate a high level system and process flow for communication of UGC between one or more client systems and OTT providers according to some embodiments.

FIGS. 18-20 illustrate different GUIs for use according to some embodiments.

### DETAILED DESCRIPTION

In the following description, for the purposes of explanation, specific details are set forth in order to provide a thorough understanding of embodiments of the present disclosure. However, it will be apparent that various embodiments may be practiced without these specific details. For example, circuits, systems, algorithms, structures, techniques, networks, processes, and other components may be shown as components in block diagram form in order not to obscure the embodiments in unnecessary detail. The figures and description are not intended to be restrictive.

The some embodiments, such as those disclosed with respect to the figures in this disclosure, may be described as a process which is depicted as a flowchart, a flow diagram, a data flow diagram, a structure diagram, a sequence diagram, or a block diagram. Although a sequence diagram or a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The processes depicted herein, such as those described with reference to the figures in this disclosure, may be implemented in software (e.g., code, instructions, program) executed by one or more processing units (e.g., processors cores), hardware, or combinations thereof. The software may be stored in a memory (e.g., on a memory device, on a non-transitory computer-readable storage medium). In some embodiments, the processes depicted in sequence diagrams and flowcharts herein can be implemented by any of the systems disclosed herein. The particular series of processing steps in this disclosure are not intended to be limiting. Other sequences of steps may also be performed according to alternative embodiments. For example, alternative embodiments of the present disclosure may perform the steps outlined above in a different order. Moreover, the individual steps illustrated in the figures may include multiple sub-steps that may be performed in various sequences as appropriate to the individual step. Furthermore, additional steps may be added or removed depending on the particular applications. One of ordinary skill in the art would recognize many variations, modifications, and alternatives.

In an aspect of some embodiments, each process in this figures of this disclosure can be performed by one or more processing units. A processing unit may include one or more processors, including single core or multicore processors, one or more cores of processors, or combinations thereof. In some embodiments, a processing unit can include one or more special purpose co-processors such as graphics processors, digital signal processors (DSPs), or the like. In some embodiments, some or all of processing units can be implemented using customized circuits, such as application specific integrated circuits (ASICs), or field programmable gate arrays (FPGAs).

I. Architecture of Content Distribution and Communication System

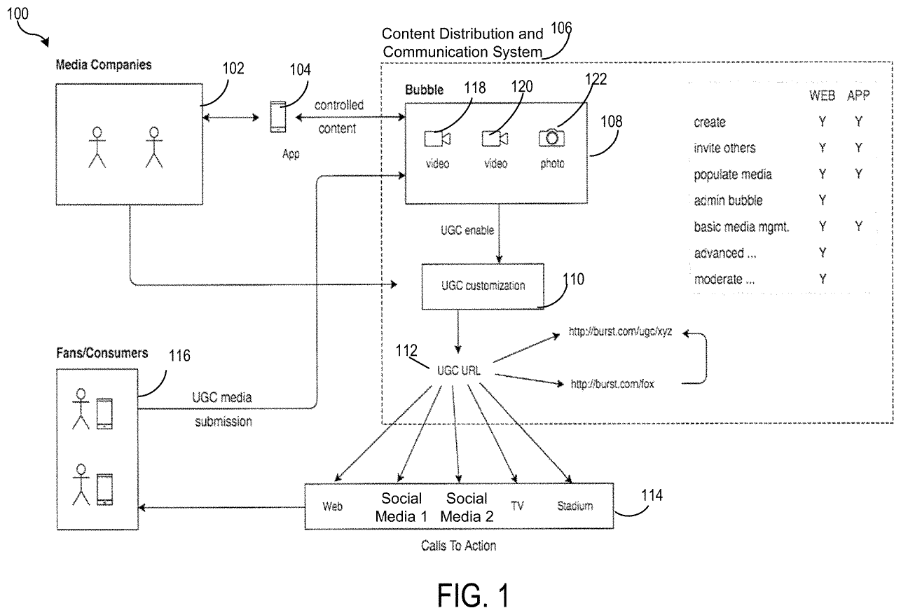

FIG. 1 shows a block diagram of a system 100 for enabling a user to provide media content, such as user generated content (UGC), to a broadcast system according to an embodiment of the present disclosure.

Media content (also referred herein as “media”) may be represented by data (e.g., also referred to herein as content data) in an electronic form (e.g., electronic media content). Media content may include one or more types of content, including, but not limited to, a file, an image, a video, audio, other electronic media content, or combinations thereof. Content data for media content may be unstructured, structured, or a combination thereof. Media content may be defined based on one or more formats. Media content may be defined as having a format using, without limitation, hypertext markup language (HTML), cascade style sheets (CSS), JavaScript, or other formatting techniques and languages. A format may indicate a style for presenting media content. Media content may be presented in a manner, which the media content can be perceived by a user. In some embodiments, metadata may indicate information (e.g., an attribute) about or associated with media content. Some media content may be generated or created by a user (e.g., a consumer). Such media content may be referred to as “user generated content” (UGC) or “user created content” (UCC).

A broadcast system 102 may broadcast media content to users. The broadcast system may be managed by one or more media companies or other entity. A broadcast system may be implemented by one or more computer systems. Broadcast system 102 may provide a destination where content can be provided for incorporation into a broadcast by broadcast system 102.

A broadcast system may be implemented using a computer system, which may comprise one or more computers and/or servers which may be general purpose computers, specialized server computers (including, by way of example, PC servers, UNIX servers, mid-range servers, mainframe computers, rack-mounted servers, etc.), server farms, server clusters, distributed servers, or any other appropriate arrangement and/or combination thereof. The computing system that makes up content system 106 may run any of operating systems or a variety of additional server applications and/or mid-tier applications, including HTTP servers, FTP servers, CGI servers, Java servers, database servers, and the like. Exemplary database servers include without limitation those commercially available from Microsoft, and the like. In one example, content system 106 may be included in or implemented in a product (e.g., BurstOnTV) provided by Burst, Inc. In various embodiments, content system 106 may be configured to run one or more services or software applications described in the foregoing disclosure. For example, content system 106 may correspond to a computing system for performing processing as described herein according to an embodiment of the present disclosure.

Content system 106 may be implemented using a computer system, which may comprise one or more computers and/or servers which may be general purpose computers, specialized server computers (including, by way of example, PC servers, UNIX servers, mid-range servers, mainframe computers, rack-mounted servers, etc.), server farms, server clusters, distributed servers, or any other appropriate arrangement and/or combination thereof. The computing system that makes up content system 106 may run any of operating systems or a variety of additional server applications and/or mid-tier applications, including HTTP servers, FTP servers, CGI servers, Java servers, database servers, and the like. Exemplary database servers include without limitation those commercially available from Microsoft, and the like. In one example, content system 106 may be included in or implemented in a product (e.g., BurstOnTV) provided by Burst, Inc. In various embodiments, content system 106 may be configured to run one or more services or software applications described in the foregoing disclosure. For example, content system 106 may correspond to a computing system for performing processing as described herein according to an embodiment of the present disclosure.

Broadcast system 102 may communicate with one or more clients systems 104 (referred to herein as “client system” or “client”). Broadcast system 102 may communicate with a content distribution and communication system 106 (also referred to herein as a “content system”). Broadcast system may communicate with media system through one or more client systems. Client systems may include devices 116 operated by users (e.g., fans and/or consumers). Consumers may generate UGC for submission to content system 106. A client system may be a device or an application (also referred to herein as an “app”) operating on a device. Client system 104 may be a user-operated computing device that may be implemented using hardware, firmware, software, or combinations thereof to interact with content system 106. For example, client system 104 may be a client device, including, without limitation, a desktop computer, a laptop computer, a tablet computer, a smart phone, a wearable computing device, a personal digital assistant, and so on. Client system 104 may be a device implemented as an iPhone provided by Apple Corporation, an Android-based device, or other mobile communication device.

An application may be stored and executed locally on a client system. In some embodiments, all or part of an application may be hosted and executed remotely on a computing system, e.g., content system 106, accessible to a client system. An application may be implemented as a client app executing on an operating system of a client system, a web browser that interfaces with a web based messaging service, a service-specific application provided by content system 106, or another app. For example, an application may be implemented by content system 106 and accessed from a client system, a broadcast system or combinations thereof. In some embodiments, an application may be provided as a service by content system 106.

Content system 106 may be implemented using a computer system, which may comprise one or more computers and/or servers which may be general purpose computers, specialized server computers (including, by way of example, PC servers, UNIX servers, mid-range servers, mainframe computers, rack-mounted servers, etc.), server farms, server clusters, distributed servers, or any other appropriate arrangement and/or combination thereof. The computing system that makes up content system 106 may run any of operating systems or a variety of additional server applications and/or mid-tier applications, including HTTP servers, FTP servers, CGI servers, Java servers, database servers, and the like. Exemplary database servers include without limitation those commercially available from Microsoft, and the like. In one example, content system 106 may be included in or implemented in a product (e.g., BurstOnTV) provided by Burst, Inc. In various embodiments, content system 106 may be configured to run one or more services or software applications described in the foregoing disclosure. For example, content system 106 may correspond to a computing system for performing processing as described herein according to an embodiment of the present disclosure.

In some embodiments, content system 106 may be implemented as an enterprise computing system or a cloud computing system comprising one or more computers and/or servers that may include those described above. Content system 106 may include several subsystems and/or modules, including some, which may not be shown. Content system 106 may have more or fewer subsystems and/or modules than shown in the figure, may combine two or more subsystems and/or modules, or may have a different configuration or arrangement of subsystems and/or modules. Subsystems and modules of content system 106 may be implemented in software (e.g., program code, instructions executable by a processor), firmware, hardware, or combinations thereof. In some embodiments, the software may be stored in a memory (e.g., a non-transitory computer-readable medium), on a memory device, or some other physical memory and may be executed by one or more processing units (e.g., one or more processors, one or more processor cores, one or more GPUs, etc.).

In certain embodiments, content system 106 may also provide other services or software applications can include non-virtual and virtual environments. For example, content system 106 may be implemented as a cloud-based system which operates as a cloud by communicating with client systems and broadcast systems using one or more communication networks (e.g., the Internet). In some embodiments, these services may be offered as web based or cloud services or under Software as a Service (SaaS) model to the users of broadcast systems and client systems. The services and/or applications may be provided via a communication network, such as the Internet. The services offered by content system 106 may include application services. Content system 106 may be accessed using one or more applications to utilize the services or applications provided by content system 106. Application services may be provided by content system 106 via a SaaS platform. The SaaS platform may be configured to provide services that fall under the SaaS category. The SaaS platform may manage and control the underlying software and infrastructure for providing the SaaS services. By utilizing the services provided by the SaaS platform, customers can utilize applications executing in content system 106, which may be implemented as a cloud infrastructure system. Users can acquire the application services without the need for customers to purchase separate licenses and support. Various different SaaS services may be provided.

Users operating client system 104 may in turn utilize one or more applications to interact with content system 106 to utilize the services provided by subsystems and/or modules of content system 106. Services may be offered as a self-service or a subscription. In some embodiments, a specific instantiation of a service provided by content system 106 may be referred to herein as a “service.” A service made available to a user via network (e.g., a communication network) from content system 106 is referred to as a “cloud service.” In some embodiments, content system 106 may host an application, and a user may, via a network, access the application at on demand. For example, a user operating a client system 104 may facilitate communication between broadcast system 102 and content system 106.

Content system 106 may include at least one memory, one or more processing units (or processor(s)), and storage. The processing unit(s) may be implemented as appropriate in hardware, computer-executable instructions, firmware, or combinations thereof. Computer-executable instructions or firmware implementations of the processing unit(s) may include computer-executable or machine-executable instructions written in any suitable programming language to perform the various operations, functions, methods, and/or processes described herein. The memory in content system 106 may store program instructions that are loadable and executable on the processing unit(s), as well as data generated during the execution of these programs. The memory may be volatile (such as random access memory (RAM)) and/or non-volatile (such as read-only memory (ROM), flash memory, etc.). The memory may be implemented using any type of persistent storage device, such as computer-readable storage media. In some embodiments, computer-readable storage media may be configured to protect a computer from an electronic communication containing malicious code. The computer-readable storage media may include instructions stored thereon, that when executed on a processor, perform the operations described herein.

Communication between elements in system 100 may be facilitated using one or more communication networks of various types. Examples of communication networks include, without restriction, the Internet, a wide area network (WAN), a local arear network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk, Bluetooth®, and other protocols. In some embodiments, communication may be facilitated using one or more messaging services. Examples of messaging services may include email services such as Gmail™ (a service of Google Inc.) and Yahoo! ® Mail (a service of Yahoo! Inc.). Other examples may include instant messaging or chat services such as Gmail's chat feature or Facebook's chat (a service of Facebook, Inc.), a short message service (SMS) and/or a multimedia messaging service (MMS) provided by cellular data carriers, social network services with a messaging component (e.g., social networks provided by Facebook, Inc., or Linkedln Corp.).

A “message” may include any electronic communication generated by a sender and directed to one or more recipients, such as email messages, instant messages (e.g., messages sent between users using various “chat” services), SMS/MMS messages (e.g., messages conforming to SMS and/or MMS protocols supported by various cellular and other wireless data networks), voice messages, photo/image messages, social network messages, and so on. In some embodiments, communication may be facilitated using a push notification system implemented by a push notification service (e.g., Apple push notification service provided by the Apple® corporation or Google notification service provided by the Google® corporation).

Content system 106 may provide an interface (e.g., a graphical interface) to access features of content system 106. The interface may be provided as an application or a service. An interface may enable a user to create one or more data storage structures, such as a data storage container 108 (also referred to herein as a “bubble”), to store media content, such as UGC. The bubble 108 may be implemented using software, hardware, firmware, or combinations thereof for receiving and storing media. A bubble may be implemented using one or more data stores.

Any of the data stores (or data storage systems) disclosed herein may be implemented using any type of persistent storage device, such as a memory storage device or other non-transitory computer-readable storage media. In some embodiments, local storage may include or implement one or more databases (e.g., a document database, a relational database, or other type of database), one or more file stores, one or more file systems, or combinations thereof. Memory and the additional storage are all examples of computer-readable storage media. For example, computer-readable storage media may include volatile or non-volatile, removable or non-removable media implemented in any method or technology for storage of information such as computer-readable instructions, data structures, program modules, or other data.

The content in a bubble may be associated with a broadcast of media content. A bubble may be created by media companies and fans/consumers. A bubble may be created to store UGC having one or more attributes, such as a particular event, a theme, a location, a time, a broadcast, etc. A bubble may be created for access through a web based interface and/or an application. A user (e.g., an administrator of content) may manage content in a bubble. One or more management attributes may be configured for a bubble. For example, management attributes may include, without limitation, creating, reading, updating, deleting, inviting others, populating media, administration, media management, advanced functions, moderate functions, or other media use and management functions.

Upon creation of a bubble 108 and enabling reception of UGC, a bubble can be customized by content system 106. Content system 106 may include a customization module 110 which can configure and/or customize a bubble. Customization module 110 may generates a unique address or location, such as a uniform resource locator (URL) 112. A URL can be randomly generated, or can be a vanity URL with the name of the sponsor, for example. The URL can then be advertised to fans/consumers via various media channels 114, such as on a web page, social media channels (e.g., Facebook®, or Twitter®), TV or a Stadium big screen.

Users (e.g., fans, consumers, and/or viewers) can operate their devices 116 to obtain media content (e.g., videos, photos, audio recordings, graphics and other media) and upload the media content to bubble 108 using the URL 112. Bubble 108 can store media content, such as multiple videos 118, 120 and photos 122 along with other media. Multiple bubbles can be used. These uploads are optimized for the connectivity conditions and the quality levels of the media to ensure successful uploads with the least detriment to media quality.

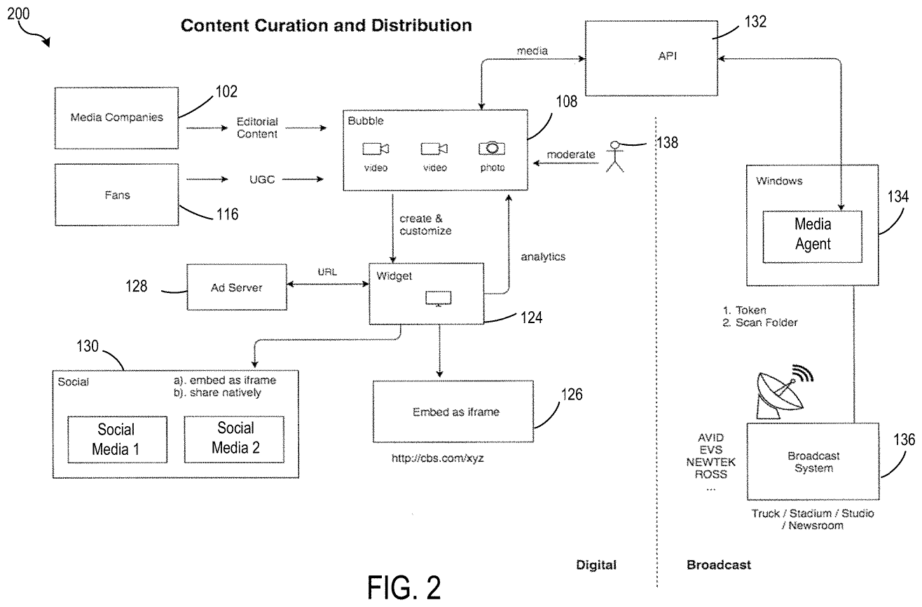

FIG. 2 is a block diagram illustrating a system 200 for content curation and distribution according to an embodiment. System 200 may be implemented using all or some of elements of FIG. 1, such as content system 106. Both UGC from devices 116 of fans and editorial content from broadcast systems 102 of media companies can be provided to one or more bubbles (e.g., bubble 108) at content system 106. The media content in bubble 108 can then be approved and curated by one or more mediators 138. Derivative or modified media can be created and customized using an application (e.g., a widget 124) accessible through content system 106. The widget can provide the derivative media to a variety of media destinations, such as media distribution channels using an iframe 126) for embedding in a website or a native app, an ad server 128 for providing to other websites and distribution channels, and social media sites 130, such as Facebook® or Twitter®. Alternately, the media content can be provided through a programming interface (e.g., an API 132) to a Windows, Mac OS X, Linux or other platform 134 for use by a broadcast system 136 (e.g., broadcast system 102). Platform 134 may be implemented by an entity that is different from a company associated with broadcast system 136. For example, the entity may be a production company that provides services to a broadcast system. Platform 134 may be implemented using one or more computer systems, such as any of those described for a broadcast system. Platform 134 may be implemented with programming code (e.g., an application), such as a media agent, configured for communication with content system 106 and broadcast system 136.

The broadcast system 136 may be a truck, a stadium control room, a media production studio or a newsroom, for example. The API 132 provides the media content to a broadcast format customized for the particular broadcast system 136. The media content may be converted from a digital format (e.g., an Internet-based format) to the broadcast format.

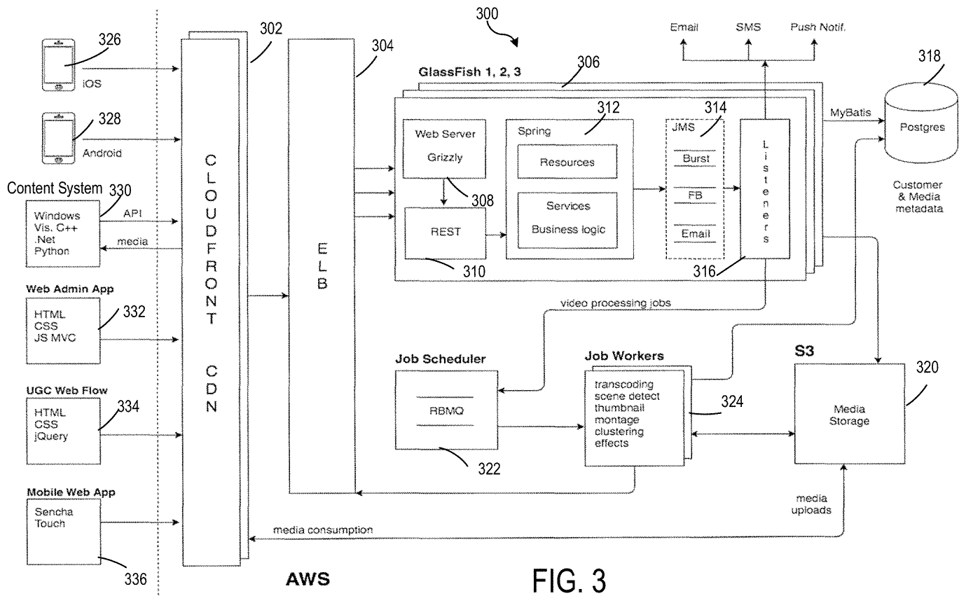

FIG. 3 is a block diagram illustrating a system 300 including a bubble and widget architecture according to an embodiment. System 300 may be implemented in or with system 100. Bubble 108 and widget 124 of FIG. 2 may be implemented as shown in FIG. 3. A programming interface, such as interface 302 may be implemented using one or more computer systems, such as an edge service. Interface 302 may be implemented as a cloud-based CDN (Content Delivery Network) to receive and send data. An example of a CDN may be a Cloudfront CDN provided by Amazon Web Services. Interface 302 may be implemented as part of content system 106.

System 300 may include one or more load balancers, such as an ELB (Elastic Load Balancer) 304. ELB 304 can route API calls to a cluster of server systems 306, such as one or more server computers implemented using GlassFish open source. ELB 304 may be implemented in content system 106. System 300 may include a web server 308, such as a Grizzly server, provides web based services (e.g., HTTP services) and multiple thread management. Server 308 uses a REST (Representational State Transfer) service 310—an architectural style for networked hypermedia applications used to build Web services that are lightweight, maintainable, and scalable.

System 300 may include an interface 312, such as a Spring interface, provides a common interface for diverse resources, such as transaction management, authentication and session control. Interface 312 communicates with a Java Message Service (JMS) 314, which can enable asynchronous processing for various actions such as sending messages through email, SMS and push notifications. An event listener 316 detects events, and can push them out and store them in a database 318, such as an open source Postgres database or deliver them to other external systems. The database 318 also stores all meta data, consumer information and all the data necessary to process, curate and distribute the media.

A media storage database 320 can store the media received through various bubbles. A job scheduler 322 schedules jobs for job workers 324, which handle various processing functions such as transcoding, scene detection, thumbnail detection, montage creation, clustering and applying effects to media.

Each of the elements 302-324 can be implemented in or with content system 106.

Interface 302 can be an edge server that interfaces with various input and output applications, such as user mobile devices 326 and 328, a content system 330 (e.g., a system for BurstOnTV provided by Burst, Inc.), a web administrator application 332, a UGC (User Generated Content) web flow application 334 and a mobile web application 336.

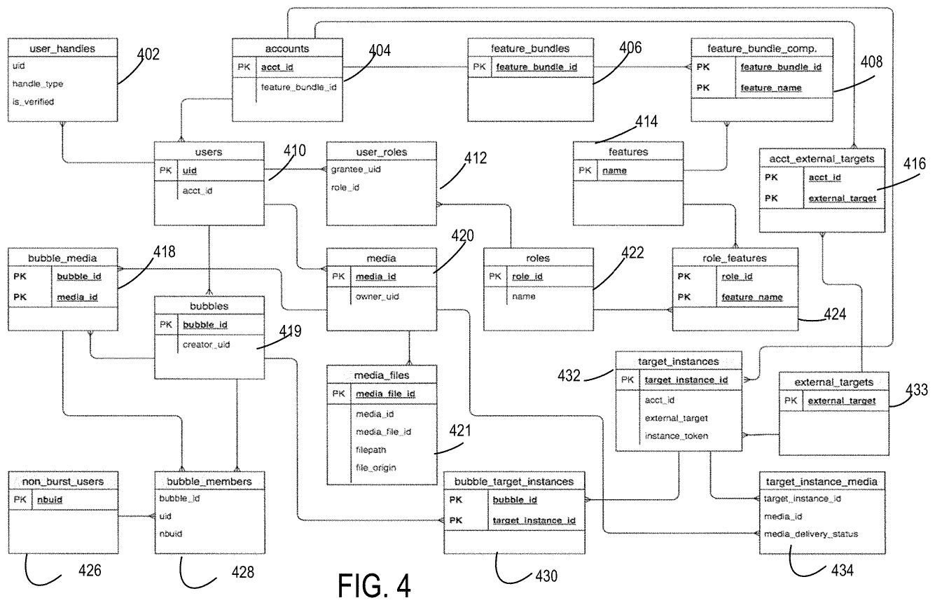

FIG. 4 is a diagram of a subset of data structures as implemented in an embodiment. The total set of tables can be hundreds of tables or more. User_handles 402 identify particular users, with each user having a user ID 410 and user_roles 412 selected from roles 422 which have role_features 424. Accounts 404 identify particular customer accounts. Feature bundles 406 provide combinations of features 414 as specified in feature bundle_components. 408.

Bubble media 418 identifies which media 420 are in which bubbles. Media files 421 can tracks each media file associated with each item of media content, such as thumbnail files of various sizes, and video files of different quality levels and resolutions generated via transcoding from a single original user submitted media file. Bubbles 419 can be associated with bubble members 428, to indicate who are direct invitees to a bubble, which can include non-registered-users 426 or registered users 410.

External targets 433 are the broadcast and production systems to which media can be delivered. Target_instances 432 are the individual instances of such external targets. Thus, each target instance is a truck or a studio or a stadium control room running the broadcast system specified by the associated external target. Bubble_target_instances 430 relate one or more bubbles to one or more target instances. There is a one-to-many relationship in both directions. Thus, one bubble can feed many trucks and many studios, and one truck or studio can be fed by many different bubbles. Acct_external_target 416 indicates which external systems each account in accounts 404 is provisioned for. For example, an account may be provisioned for EVS, and certain target instances also known as destinations (trucks or studios) of an account may be provisioned for EVS. Target_instance_media 434 keeps track of every destination to which media has been sent, and what is the status assigned to the media, such as downloaded, ingested, failed, etc. External targets of accounts 416 are selected from external_targets 433. Target_instances 432 link to target_instance_media 434 and bubble target_instances 430.

Each piece of media content can have many files associated with the original file the user sends. Those files include all of the transcoder variations of the files including thumbnails of various different shapes and the streams for the media. The media files themselves are stored, in one embodiment, on a storage service such as Amazon S3. The database tables reference the actual media locations on Amazon S3. The customer and media metadata are stored in the tables rather than in Amazon S3 in one embodiment.

II. Interfaces for Content Distribution and Communication System

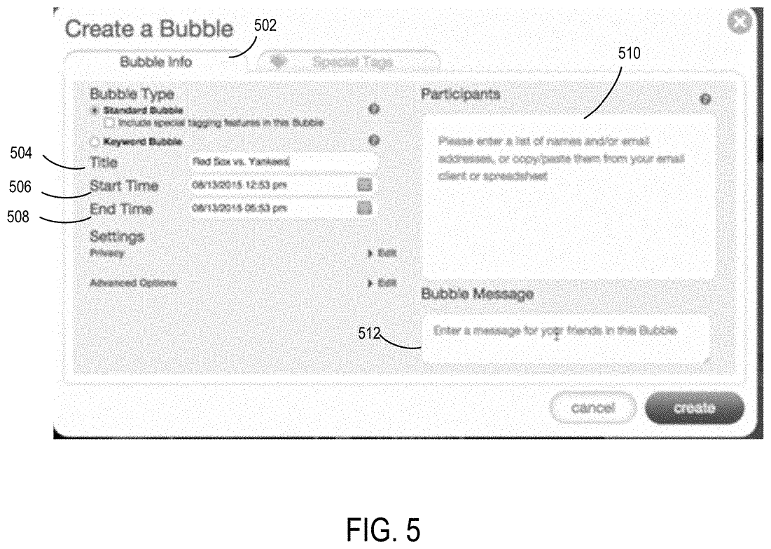

FIGS. 5-13 illustrate interfaces according to some embodiments. Each of the interfaces may be displayed at a device or a computer system. For example, an interface mau be presented at a client system, a broadcast system, or combinations thereof. Interfaces may include an interface, such as a physical interface, a graphical interface (e.g., a graphical user interface), or a combination thereof. A graphical interface may be generated by a device and/or received from content system 106, or a combination thereof. An interface may be updated, modified, enhanced, and regenerated, without restriction, in response to one or more events (e.g., an interaction with the graphical interface). Examples of graphical interfaces are disclosed herein with reference to the figures. The graphical interface(s) enable functionality disclosed herein, such as functionality of content system 106. A graphical interface may be provided by content system 106 via a network as part of a service (e.g., a cloud service or a web based service) or application. In some embodiments, a device may provide access to one or more applications. An application may enable a user to access and perform services provided by content system 106.

In this disclosure, “an element” may be included in an interface. An element may be displayable and/or part of an interface. Examples of elements include, without limitation, a control, a button, a navigation bar, or other visible component that can be part of an interface that can be perceived by sound, vision, touch, or combinations thereof. An element can receive input. For example, an interactive element may be an element that is interactive to receive input. An interactive element may receive input to enable interaction with the graphical interface

FIG. 5 is a diagram of a graphical user interface for an individual to create a bubble according to an embodiment. A bubble info tab 502 provides various fields for defining attributes of the bubble. A bubble title 504 is provided, along with a start time 506 and an end time 508. A participant's field 510 allows the entry of names, phone numbers and/or email addresses of those who will be invited to submit media to the bubble. A bubble message field 512 provides a message to participants.

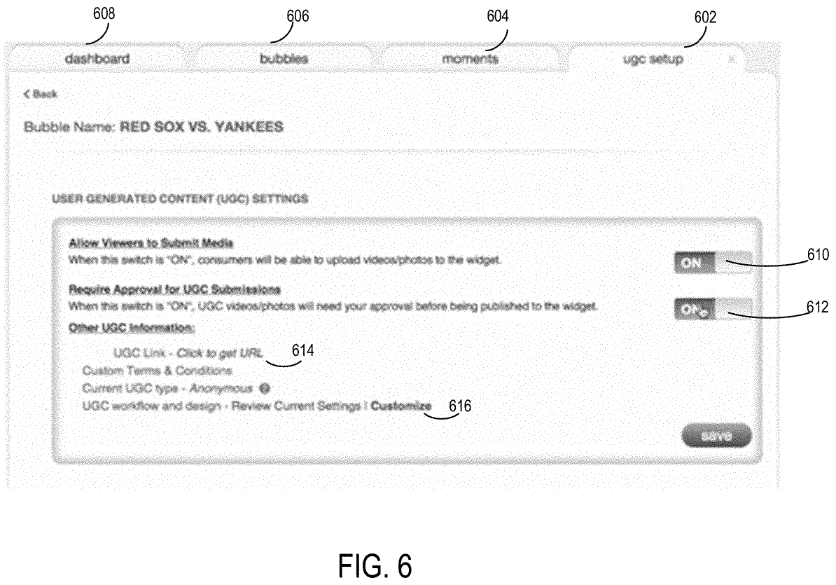

FIG. 6 is a diagram of a graphical user interface for UGC settings for a bubble according to an embodiment. A UGC setup tab 602 is shown. Other tabs are provided as well, including a moments tab 604, a bubbles tab 606 and a dashboard tab 608. Moments tab 604 allows managing of media. Bubbles tab 606 provides for managing multiple bubbles, and selecting a particular bubble. Dashboard tab 608 provides for tracking views, media, bubbles and adding new media and bubbles. Shown on tab 602 is a particular selected bubble. A switch 610 allows setting the bubble to “ON” which allows viewers to submit media. A button 612 can be used to require approval before any UGC is published to a widget (e.g., widget 124 of FIG. 2). For a media company, particular editors can be given approval control via an administrative setting. A line 614 can be clicked to obtain a URL for the bubble. A link 616 (a URL) allows customization of the UGC workflow and design.

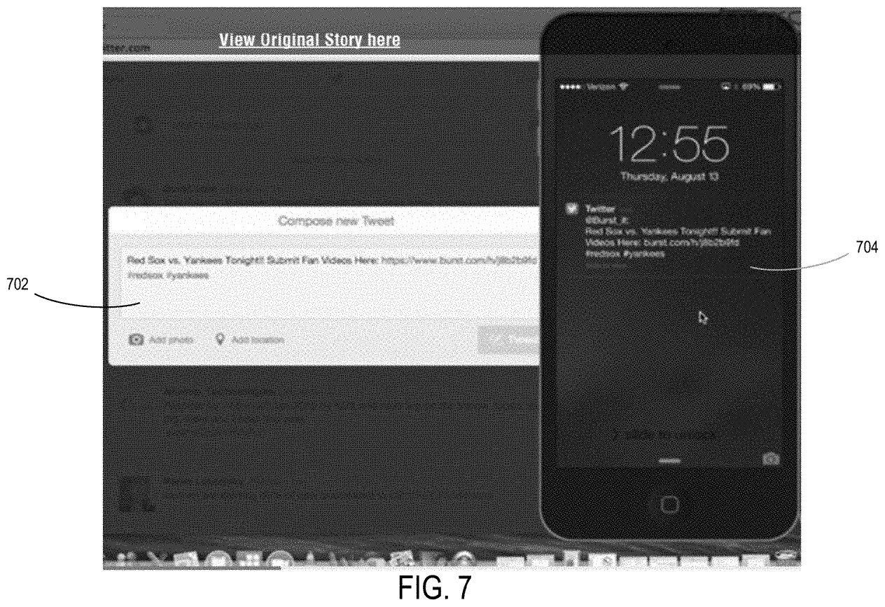

FIG. 7 is a diagram of a graphical user interface for sharing media content from a bubble on Twitter®, according to an embodiment. A window 702 is shown for composing a new tweet. The tweet can include the URL to use for media submissions. An interface to Twitter® is provided as shown as part of the social interface 130 of FIG. 2. The tweet 704 is shown as it appears on a user device. As described above, other media can be similarly used, such as Facebook®, email mailing lists, etc.

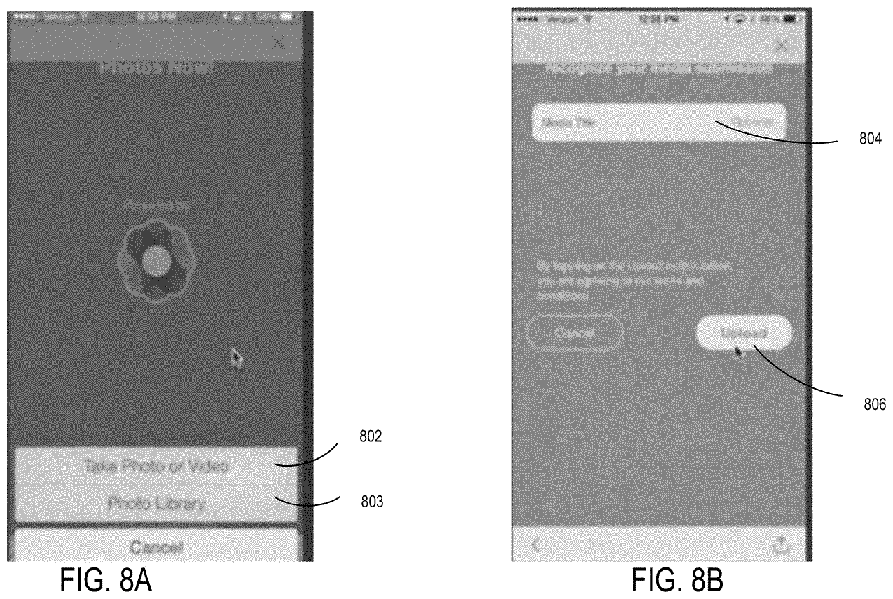

FIGS. 8A-B are diagrams of a graphical user interface for submitting media to a bubble according to an embodiment. As shown in FIG. 8A, the user can go to the URL provided, for example, as shown in FIG. 7. Instead of downloading an app to the user, the URL provides a website which does all the prompting and processing needed to help the user to upload media. The user is then prompted with a button 802 to take a photo or video, or with a button 803 to select a photo or video already taken. As shown in FIG. 8B, The user can optionally provide a name for the media in field 804, and then can upload the media using button 806. Although photos and videos are shown in this example, other media can be uploaded, such as audio recordings, graphics, or other documents.

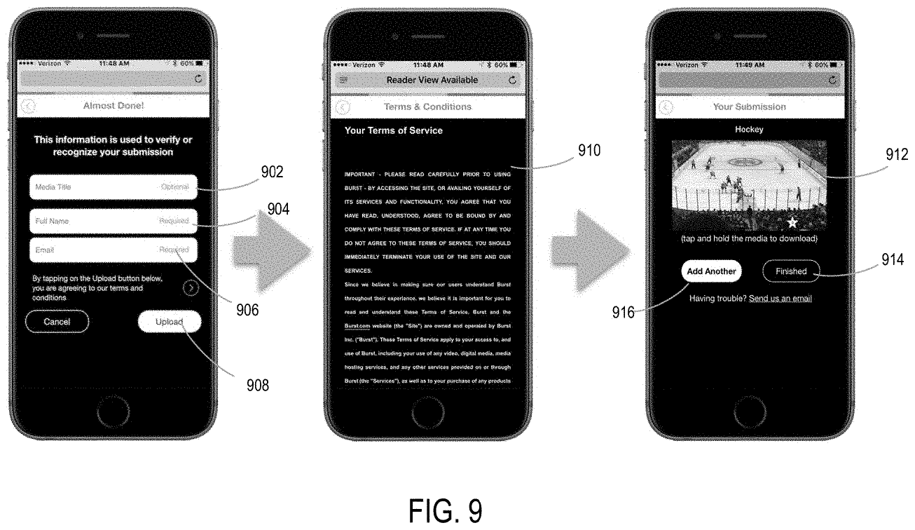

FIG. 9 is a diagram of additional elements of a graphical user interface for submitting media to a bubble according to an embodiment. A new user is prompted to enter a media title in field 902, the user's name in field 904 and the user's email address in field 906. The user's name and email are used to register, and can automatically be provided for subsequent uploads from the same device.

An upload button 908 initiates the upload. The upload is optimized for the available bandwidth on the device at that moment. The media is chunked into small chunks as specified by a server-side customizable parameter for access from content system 106. Multiple parallel connections to the content system 106 are initiated. The progress of uploading each chunk is monitored. Periodically, additional parallel connections are initiated if the bandwidth is available to support that. If the uploads begin to slow down, parallelization is reduced. Failed chunk uploads are retried automatically. In one embodiment, the connections to content system 106 are made to an edge server within the CloudFront CDN, which is specifically customized and utilized to handle uploads. By clicking the upload button 908, the user is agreeing to the terms and conditions, as shown in screen 910. This provides the consent of the user for use of the uploaded media. The media as uploaded is then shown in screen 912 for user verification by clicking a “Finished” button 914. Alternately, the user may click “add another” button 916 to initiate another upload, and return to the photo/media selection screen of FIG. 8A. The customer can decide through the UGC setup tab 602 whether they want the terms and conditions presented in a manner that requires reading them first, or not.

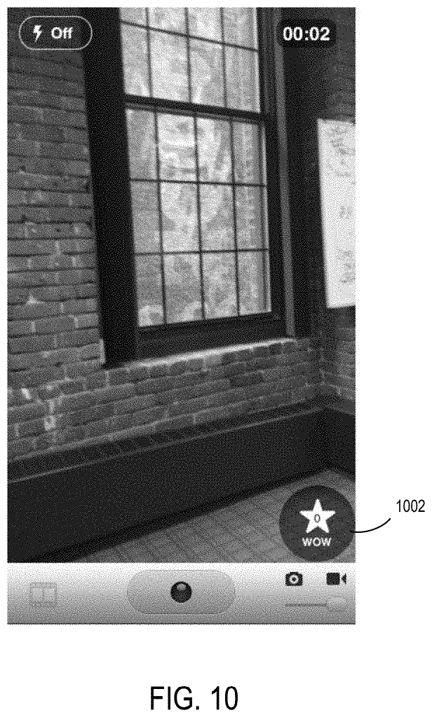

FIG. 10 is a diagram illustrating the addition of a WOW marker to UGC media according to an embodiment. A WOW button 1002 is shown that can be used to indicate particularly good photos or videos or other media, or particularly good portions. In one embodiment, the WOW button can pop-up on a video for the user to click to indicate the start of the good portion, and the user can click again at the end of the good portion. In alternate embodiments, the WOW button can be pulled up from a menu, caused to appear with a particular keystroke or combination of keystrokes or gestures, or can be provided in other ways. The WOW marker could be initiated by the user verbally saying “WOW” in another example. The WOW marker is added to the meta data for the media, along with a timestamp for the start and stop times of the WOW marker, if applicable. If particular start and stop times are not indicated, the WOW marker applies to the whole video or other media.

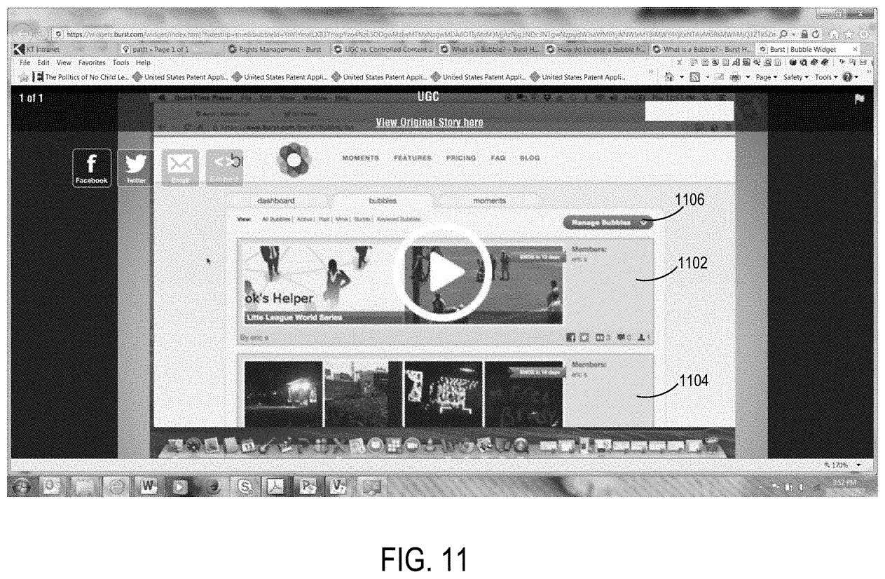

FIG. 11 is a diagram illustrating multiple bubbles according to an embodiment. Two bubbles 1102 and 1104 are illustrated, each being displayed with a thumbnail of the videos/photos in the bubble. The user can select to see all bubbles, the user's own bubbles, or can search for bubbles by keyword. The user can click the “Manage Bubbles” button 1106 to manage a group of bubbles or a particular bubble.

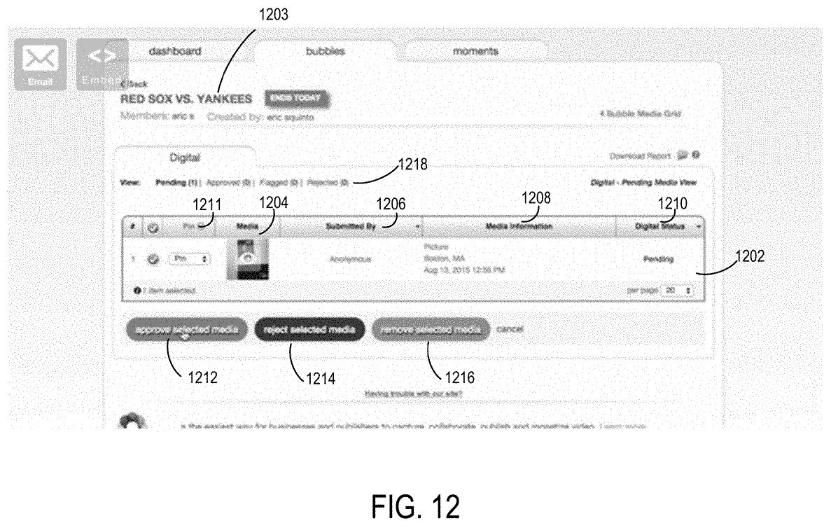

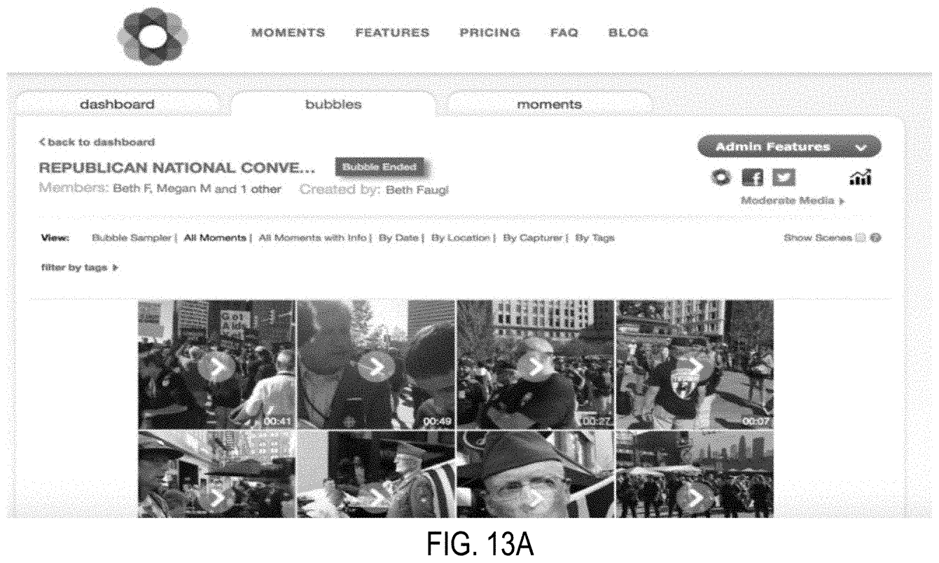

FIG. 12 is a diagram illustrating the management of media in a bubble according to an embodiment. A window 1202 identifies a particular media with a title 1203, a thumbnail 1204 and metadata. The metadata includes the name of the submitter 1206, or anonymous, and media information 1208 including the type of media, the location where the media was recorded, and the time when the media was recorded. The status 1210 is also indicated (“pending” status in this example). The window 1202 is managed by an editor with editing or approval rights. The editor can click the thumbnail to view the media. The editor can further decide to position the media at particular position within the bubble, or “pin” it by using a pin field 1211. The editor can then select key 1212 to approve the selected media for publishing, reject the media with button 1214 or remove the media with button 1216. The editor can use menu 1218 to switch between different groupings of media to view, such as pending, approved, flagged and rejected.

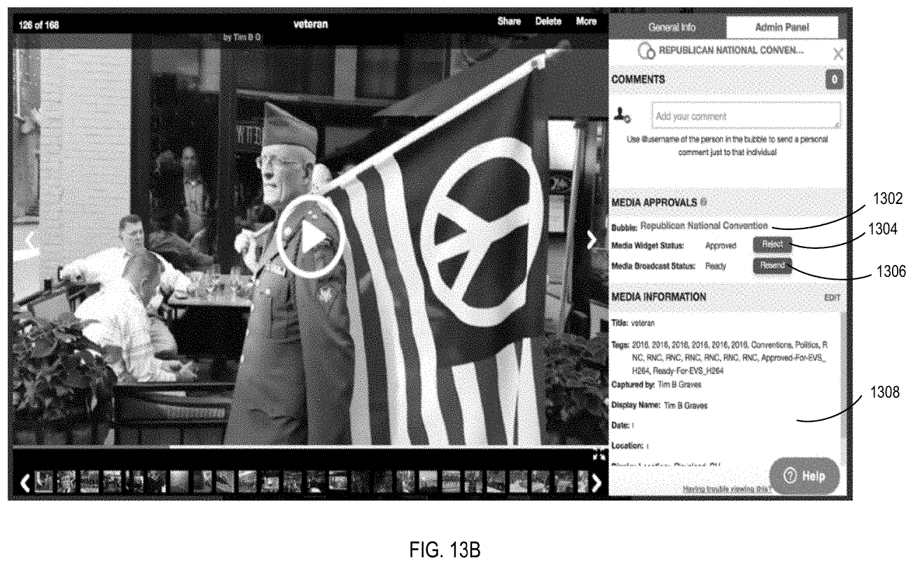

FIGS. 13A-13B are diagrams illustrating a bubble and information about media in the bubble according to an embodiment. FIG. 13A illustrates thumbnails of a variety of media in a bubble. FIG. 13B shows the selection of a particular media, with an information panel. The panel includes the bubble name 1302 and buttons for media widget status 1304 and media broadcast status 1306. A media information field 1308 includes metadata associated with the media.

III. Computer Systems for Content System and Client System

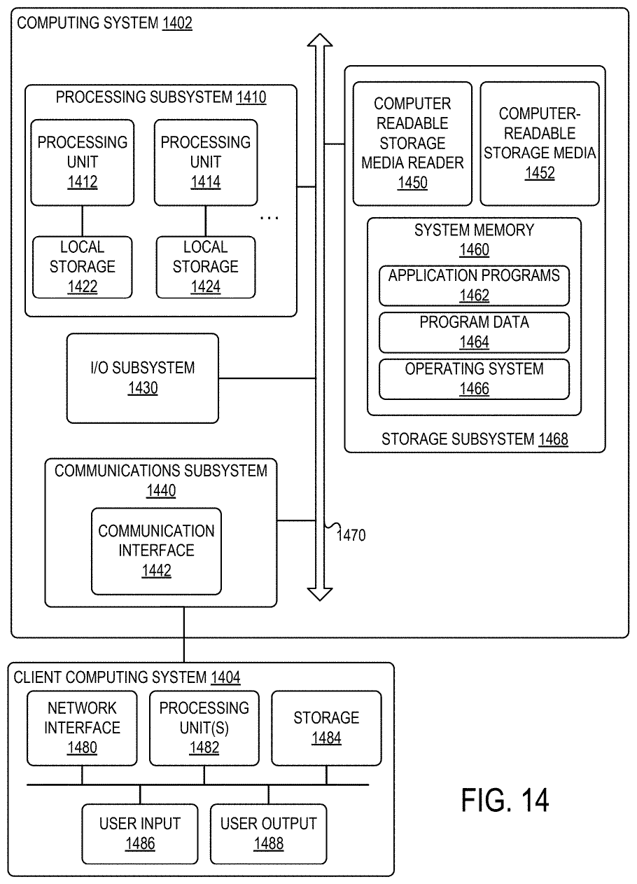

Various operations described herein may be implemented on computer systems, which may be of generally conventional design. FIG. 14 shows a simplified block diagram of a representative computing system 1402 and client computing system 1404 usable to implement certain embodiments of the present disclosure. In various embodiments, computing system 1402 or similar systems may implement the Burst servers or computers, or any other computing system described herein or portions thereof. Client computing system 1404 or similar systems may implement user devices or broadcast destination devices, or other client systems described herein.

Computing system 1402 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 1402 may include processing subsystem 1410. Processing subsystem 1410 may communicate with a number of peripheral systems via bus subsystem 1470. These peripheral systems may include I/O subsystem 1430, storage subsystem 1468, and communications subsystem 1440.

Bus subsystem 1470 provides a mechanism for letting the various components and subsystems of server computing system 1404 communicate with each other as intended. Although bus subsystem 1470 is shown schematically as a single bus, alternative embodiments of the bus subsystem may utilize multiple buses. Bus subsystem 1470 may form a local area network that supports communication in processing subsystem 1410 and other components of server computing system 1420. Bus subsystem 1470 may be implemented using various technologies including server racks, hubs, routers, etc. Bus subsystem 1470 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 1430 may include devices and mechanisms for inputting information to computing system 1402 and/or for outputting information from or via computing system 1402. In general, use of the term “input device” is intended to include all possible types of devices and mechanisms for inputting information to computing system 1402. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g.,

Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 1402 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 1410 controls the operation of computing system 1402 and may comprise one or more processing units 1412, 1414, etc. A processing unit may include one or more processors, including single core processor or multicore processors, one or more cores of processors, or combinations thereof. In some embodiments, processing subsystem 1410 may include one or more special purpose co-processors such as graphics processors, digital signal processors (DSPs), or the like. In some embodiments, some or all of the processing units of processing subsystem 1410 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 1422, 1424. Any type of processors in any combination may be included in processing unit(s) 1412, 1414.

In some embodiments, processing subsystem 1410 may be implemented in a modular design that incorporates any number of modules (e.g., blades in a blade server implementation). Each module may include processing unit(s) and local storage. For example, processing subsystem 1410 may include processing unit 1412 and corresponding local storage 1422, and processing unit 1414 and corresponding local storage 1424.

Local storage 1422, 1424 may include volatile storage media (e.g., conventional DRAM, SRAM, SDRAM, or the like) and/or non-volatile storage media (e.g., magnetic or optical disk, flash memory, or the like). Storage media incorporated in local storage 1422, 1424 may be fixed, removable or upgradeable as desired. Local storage 1422, 1424 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 1412, 1414 need at runtime. The ROM may store static data and instructions that are needed by processing unit(s) 1412, 1414. The permanent storage device may be a non-volatile read-and-write memory device that may store instructions and data even when a module including one or more processing units 1412, 1414 and local storage 1422, 1424 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 1422, 1424 may store one or more software programs to be executed by processing unit(s) 1412, 1414, such as an operating system and/or programs implementing various server functions such as functions of content system 106, or any other server(s) associated with content system 106. “Software” refers generally to sequences of instructions that, when executed by processing unit(s) 1412, 1414 cause computing system 1402 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 1412, 1414. In some embodiments, the instructions may be stored by storage subsystem 1468 (e.g., computer readable storage media). In various embodiments, the processing units may execute a variety of programs or code instructions and may maintain multiple concurrently executing programs or processes. At any given time, some or all of the program code to be executed may be resident in local storage 1422, 1424 and/or in storage subsystem including potentially on one or more storage devices. Software may be implemented as a single program or a collection of separate programs or program modules that interact as desired. From local storage 1422, 1424 (or non-local storage described below), processing unit(s) 1412, 1414 may retrieve program instructions to execute and data to process in order to execute various operations described above.

Storage subsystem 1468 provides a repository or data store for storing information that is used by computing system 1402. Storage subsystem 1468 provides a tangible non-transitory computer-readable storage medium for storing the basic programming and data constructs that provide the functionality of some embodiments. Software (programs, code modules, instructions) that when executed by processing subsystem 1410 provide the functionality described above may be stored in storage subsystem 1468. The software may be executed by one or more processing units of processing subsystem 1410. Storage subsystem 1468 may also provide a repository for storing data used in accordance with the present disclosure.

Storage subsystem 1468 may include one or more non-transitory memory devices, including volatile and non-volatile memory devices. As shown in FIG. 14, storage subsystem 1468 includes a system memory 1460 and a computer-readable storage media 1452. System memory 1460 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 1402, such as during start-up, may typically be stored in the ROM. The RAM typically contains data and/or program modules that are presently being operated and executed by processing subsystem 1410. In some implementations, system memory 1460 may include multiple different types of memory, such as static random access memory (SRAM) or dynamic random access memory (DRAM). Storage subsystem 1468 may be based on magnetic, optical, semiconductor, or other data storage media. Direct attached storage, storage area networks, network-attached storage, and the like may be used. Any data stores or other collections of data described herein as being produced, consumed, or maintained by a service or server may be stored in storage subsystem 1468.

By way of example, and not limitation, as depicted in FIG. 14, system memory 1460 may store application programs 1462, which may include client applications, Web browsers, mid-tier applications, relational database management systems (RDBMS), etc., program data 1464, and one or more operating systems 1466. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 1452 may store programming and data constructs that provide the functionality of some embodiments. Software (programs, code modules, instructions) that when executed by processing subsystem 1410 a processor provide the functionality described above may be stored in storage subsystem 1468. By way of example, computer-readable storage media 1452 may include non-volatile memory such as a hard disk drive, a magnetic disk drive, an optical disk drive such as a CD ROM, DVD, a Blu-Ray® disk, or other optical media. Computer-readable storage media 1452 may include, but is not limited to, Zip® drives, flash memory cards, universal serial bus (USB) flash drives, secure digital (SD) cards, DVD disks, digital video tape, and the like. Computer-readable storage media 1452 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 1452 may provide storage of computer-readable instructions, data structures, program modules, and other data for computing system 1402.

In certain embodiments, storage subsystem 1468 may also include a computer-readable storage media reader 1450 that may further be connected to computer-readable storage media 1452. Together and, optionally, in combination with system memory 1460, computer-readable storage media 1452 may comprehensively represent remote, local, fixed, and/or removable storage devices plus storage media for storing computer-readable information.

In certain embodiments, computing system 1402 may provide support for executing one or more virtual machines. Computing system 1402 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 1402. Accordingly, multiple operating systems may potentially be run concurrently by computing system 1402. Each virtual machine generally runs independently of the other virtual machines.

Communication subsystem 1440 provides an interface to other computer systems and networks. Communication subsystem 1440 serves as an interface for receiving data from and transmitting data to other systems from computing system 1402. For example, communication subsystem 1440 may enable computing system 1402 to establish a communication channel to one or more client computing devices via the Internet for receiving and sending information from and to the client computing devices.

Communication subsystem 1440 may support both wired and/or wireless communication protocols. For example, in certain embodiments, communication subsystem 1440 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 1440 may provide wired network connectivity (e.g., Ethernet) in addition to or instead of a wireless interface.

Communication subsystem 1440 may receive and transmit data in various forms. For example, in some embodiments, communication subsystem 1440 may receive input communication in the form of structured and/or unstructured data feeds, event streams, event updates, and the like. For example, communication subsystem 1440 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 1440 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 1440 may also be configured to output the structured and/or unstructured data feeds, event streams, event updates, and the like to one or more databases that may be in communication with one or more streaming data source computers coupled to computing system 1402.

Communication subsystem 1440 may provide a communication interface 1442, e.g., a WAN interface, which may provide data communication capability between the local area network (bus subsystem 1470) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 1402 may operate in response to requests received via communication interface 1442. Further, in some embodiments, communication interface 1442 may connect computing systems 1402 to each other, providing scalable systems capable of managing high volumes of activity. Conventional or other techniques for managing server systems and server farms (collections of server systems that cooperate) may be used, including dynamic resource allocation and reallocation.

Computing system 1402 may interact with various user-owned or user-operated devices via a wide-area network such as the Internet. An example of a user-operated device is shown in FIG. 14 as client computing system 1402. Client computing system 1404 may be implemented, for example, as a consumer device such as a smart phone, other mobile phone, tablet computer, wearable computing device (e.g., smart watch, eyeglasses), desktop computer, laptop computer, and so on.

For example, client computing system 1404 may communicate with computing system 1402 via communication interface 1442. Client computing system 1404 may include conventional computer components such as processing unit(s) 1482, storage device 1484, network interface 1480, user input device 1486, and user output device 1488. Client computing system 1404 may be a computing device implemented in a variety of form factors, such as a desktop computer, laptop computer, tablet computer, smart phone, other mobile computing device, wearable computing device, or the like.

Processing unit(s) 1482 and storage device 1484 may be similar to processing unit(s) 1412, 1414 and local storage 1422, 1424 described above. Suitable devices may be selected based on the demands to be placed on client computing system 1404; for example, client computing system 1404 may be implemented as a “thin” client with limited processing capability or as a high-powered computing device. Client computing system 1404 may be provisioned with program code executable by processing unit(s) 1482 to enable various interactions with computing system 1402 of a message management service such as accessing messages, performing actions on messages, and other interactions described above. Some client computing systems 1404 may also interact with a messaging service independently of the message management service.

Network interface 1480 may provide a connection to a wide area network (e.g., the Internet) to which communication interface 1440 of computing system 1402 is also connected. In various embodiments, network interface 1480 may include a wired interface (e.g., Ethernet) and/or a wireless interface implementing various RF data communication standards such as Wi-Fi, Bluetooth, or cellular data network standards (e.g., 3G, 4G, LTE, etc.).

User input device 1486 may include any device (or devices) via which a user may provide signals to client computing system 1404; client computing system 1404 may interpret the signals as indicative of particular user requests or information. In various embodiments, user input device 1486 may include any or all of a keyboard, touch pad, touch screen, mouse or other pointing device, scroll wheel, click wheel, dial, button, switch, keypad, microphone, and so on.

User output device 1488 may include any device via which client computing system 1404 may provide information to a user. For example, user output device 1488 may include a display to display images generated by or delivered to client computing system 1404. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that function as both input and output device. In some embodiments, other user output devices 1488 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 1412, 1414 and 1482 may provide various functionality for computing system 1402 and client computing system 1404, including any of the functionality described herein as being performed by a server or client, or other functionality associated with message management services.

It will be appreciated that computing system 1402 and client computing system 1404 are illustrative and that variations and modifications are possible. Computer systems used in connection with embodiments of the present disclosure may have other capabilities not specifically described here. Further, while computing system 1402 and client computing system 1404 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present disclosure may be realized in a variety of apparatus including electronic devices implemented using any combination of circuitry and software.

IV. System for Communicating User Generated Content (UGC) to an OTT Provider

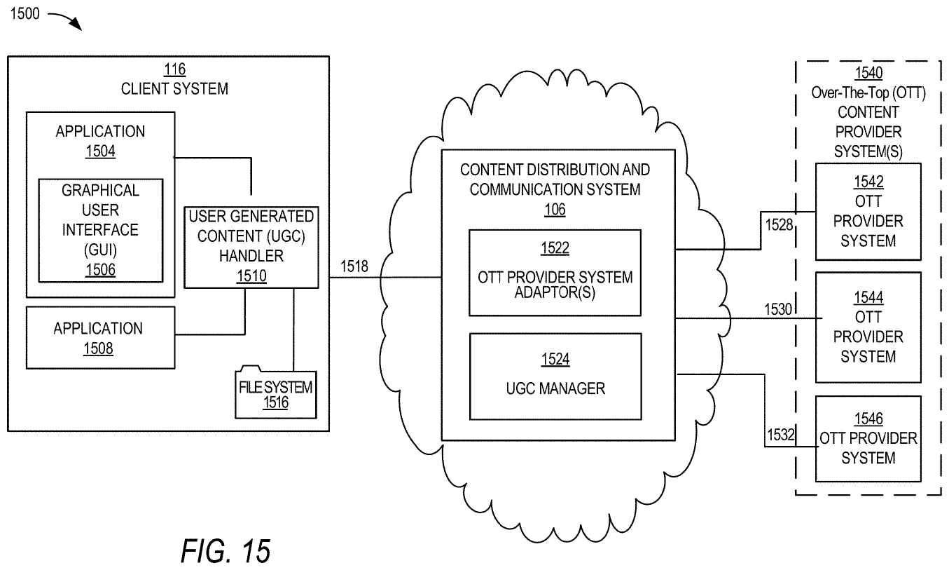

FIG. 15 is a diagram illustrating a high level system 1500 and process flow for communication of UGC between one or more client systems and OTT providers 1540, according to some embodiments. FIG. 15 discloses techniques for enabling users (e.g., viewers of content) to obtain and share user-generated content (UGC) to content providers, such as OTT content providers. The system 1500 can facilitate distribution of UGC to OTT content providers to enable display of the UGC related to the OTT content. Each OTT content provider may provide an application with a GUI that enables a user to view content provided by the OTT provider. An application provided by an OTT provider may display UGC that is obtained from content system 106 for a program.

Through content system 106, client system 116 may communicate with multiple OTT provider systems 1540 to exchange UGC. System 1500 may include multiple, different client systems, such as a client system (e.g., a mobile phone) used to capture and provide UGC to content system 106 and a client system (e.g., a media device) enabling the presentation of OTT content by the OTT provider system. In some embodiments, system 1500 includes multiple client systems, all or some of which may be used to access presentation of OTT content. UGC content obtained by one client system may be distributed by content system 106 to an OTT provider system for display at the same or a different client system along with OTT content. An OTT provider system may distribute UGC content for a particular presentation of OTT content to each of the client systems receiving the presentation of the OTT content.

Content system 106 may operate as an intermediary computer system, which may facilitate communications of content data between client systems and any of OTT provider systems 1540. Content system 106 may communicate with different types of client systems 106, including different mobile computing devices. Client systems may communicate with content system 106 through a UGC handler 1510 that handles requests to receive and/or distribute UGC. UGC handler 1510 may communicate with content system 106 using an application programming interface (API) that applications can extend to control communication of UGC to content system 106. Using the UGC handler 1510, client systems 116 can communicate with OTT provider systems through content system 106 regardless of a type of computing environment and/or applications executing on a client system.

In various embodiments, client system 116 may be configured to execute and operate one or more applications (e.g., a web browser, a client application, a proprietary client application, or the like). For example, application 1504 and application 1508 may be operated on client system 116. The client applications may be accessible or operated via one or more network(s). Applications, such as application 1504 may include a graphical user interface (GUI) 1506 for operating application. An application may facilitate capturing UGC on the client system. The application may facilitate obtaining UGC for communication to content system 106. For example, the application may store and access a file system 1516 on client system 116 for management of UGC. In some embodiments, UGC may be uploaded from a photo or video library on a client system or a cloud-based storage location.

Content system 106 may further operate as an intermediary computer system by communicating with different OTT provider systems, some of which may have different communication protocols. Such communication protocols may be custom or specific to an application or service in communication with content system 106. Further, content system 106 may communicate with an OTT provider system to send and receive UGC according to a format supported by the OTT provider system. Content system 106 may include a UGC manager 1524 for managing communication between client systems and OTT provider systems. In certain embodiments, content system 106 may include or implement one or more adaptors, e.g., OTT provider system adaptors 1522. Each of the adaptors 1522 may support communication according to a specification of an OTT provider system. For example, each of adaptors 1522 may establish one of connections 1528, 1530, 1532 to each of OTT provider system 1542, OTT provider system 1544, and OTT provider system 1546, respectively. An adaptor may be configured to communicate with an OTT provider system 1540 using an interface provided by that OTT provider system. Each adaptor may be configured for communication with an OTT provider system according to communication and video requirements, such as aspect ratio, codex, frame rate, bit rate, orientation requirements, etc.

In the example shown in FIG. 15, a user may operate a client system 116 to capture and distribute UGC to one or more OTT content provider systems 1540. Each of the OTT content provider systems 1540 can correspond to a different OTT content provider. Distribution of UGC from users to OTT content providers may be facilitated through content system 106. The system 1500 enables a user (e.g., a view of OTT content) to engage with presentation of content by providing a mechanism that enables the user to communicate UGC from the user's device (e.g., client system 116), in real-time, to a provider of OTT content. In turn, an OTT content provider can incorporate the UGC into OTT content, in real-time during the presentation of the OTT content. The UGC may be presented to other users who are viewing the program at the same time, thereby enabling users to communicate with each other by sharing UGC.

Client system 116 may be operated to capture and/or produce (e.g., edit) UGC on the client system 116. For example, graphical user interface (GUI) 106 of application 104 may enable a user to access and choose UGC content stored on the client system 116 for communication to the OTT provider. In some embodiments, the system may provide a GUI at the client system that enables the presentation of the OTT content. The GUI may be interactive to enable the user to request and/or to share UGC content with the OTT provider. For example, the GUI may enable a user to specify the destination for providing UGC content, such as a container associated with content for a program or the OTT provider directly. The content system 106 may initiate a process via the GUI that prompts the user to specify UGC content to be uploaded to the content system. The content system can communicate the UGC content to the OTT provider to make the UGC content available in a GUI of the OTT. The UGC content may be presented with a program to which the UGC content relates.

In some embodiments, the content system 106 may facilitate minimal, or no user involvement for configuration of an application for uploading UGC to the content system. Such a process may be referred to herein as app-less uploading. At the client system 116, an application 104 may be presented to upload UGC in response to presentation of a program by an OTT provider. In some embodiments, a client system presenting an OTT program may provide a GUI that enables the user to initiate a process from an OTT provider system to content system 106 to request UGC from users. Content system 106 may communicate with a client system 116 to cause the GUI to be provided for obtaining UGC. The GUI may provide information that enables the client system to render access to a location, e.g., a URL, of a container where UGC content may be uploaded. In some embodiments, a user may obtain a URL from content system 106 or an OTT provider system. The GUI may be configured to receive the URL. As a result of accessing the URL, the GUI is presented to upload UGC.

In one example, a URL may be accessed in response to a user operating a camera of the client system to capture an image (e.g., a QR code) that is configured with information (e.g., a URL for a container). The client system may be configured to process the image upon capture, which causes the URL to be accessed in an application, such as a web browser, which displays the graphical interface to upload UGC to a container.

A URL may be obtained by a client system via one or more mechanisms, such as an application (e.g., a social media application), a website (e.g., a social media website or a website of an OTT provider), an SMS message, or other application made available to a user. Some of the disclosed techniques enable a user to provide UGC content in real-time from a client system to an OTT provider, without having to download or configure an application on the client system to access the UGC content. A user can operate any client system storing UGC and communicate with different OTT providers, without configuring either of the client system of the user and the system of the OTT provider to enable communication of the UGC. The techniques further enable UGC to be communicated to an OTT provider via the content system without causing the UGC to be accessed or stored by any system, such as a system supporting a third party site through which the URL was accessed.

In at least one example, one user may be operating a client system to watch a program provided by an OTT provider. An application by the OTT provider may enable the user to engage with the program to submit content (e.g., UGC) to the provider in real-time so that the content can be provided to other users viewing the program. In this example, the application by the OTT provider may be interactive to initiate a process (e.g., provide a URL or a display a QR code in the application) whereby the user can operate the same or a different client system to provide UGC for the program. Using techniques disclosed above, content system 106 may provide information (e.g., a URL, QR code, a push notification, or an SMS message) directly to a client system or to the OTT provider to display. A URL may be accessible externally to the content system as a direct location where UGC can be uploaded. The URL may be configured by content system 106 such that an application that accesses the URL receive content to render a GUI that is interactive to enable a user to upload UGC from the client device. The URL may be provided by the content system to the client system or may be provided by OTT provider system after receiving it from the content system. The information may be encoded to indicate a container where the UGC content is to be stored by the content system. An application on a client system may be configured to receive and/or interact with delivery of the information to initiate a process for the application to access UGC for submission. In some embodiments, an application on a client system may present a GUI to receive information about the UGC being uploaded from the client system to the content system 106. The GUI may include one or more fields to provide information about the UGC include a name of a submitter, an email of the submitter, a comment, a social media attribution, social media distribution, and a title.

UGC handler 1510 on a client system 116 may be configured to communicate with content system 106 according to an interface of content system 106. UGC handler 1510 may communicate UGC to content system 106. UGC may be communicated with the information provided by a user and the information (e.g., a URL or a QR code) provided by the content system 106 for the process of obtaining UGC content. In at least one embodiment, the content system 106 may provide a programming interface, such as an application programming interface (API) that enables communication of media to and from the content system. The API may be used by an application on a client device and systems of OTT providers to communicate UGC. In some embodiments, the program code supporting the API may be configured for the content system 106 to determine how to communicate UGC to and from the content system. Specifically, when uploading UGC from a client device, and downloading UGC to an OTT provider system, the content system can consider many attributes about the UGC and the devices with which the content system is communicating. Examples of attributes about UGC include a format of the UGC, a size of the UGC, a compression factor of the UGC etc. Examples of attributes about devices may include the protocol for communication supported by the devices, the number of connections to the devices, the type of devices, the model of the devices, etc.

UGC manager 1524 may be configured to manage storage, access, and communication of UGC. UGC manager 1524 may store UGC content in a data storage container (e.g., a bubble). A data storage container may be associated with a location, such as a URL, or other information identifying a location for UGC content. The location provided with the UGC may correspond to data storage container to provide UGC for a particular OTT provider and/or program. The container may be configured by a user, such as an operator of an OTT provider, for curation and management of UGC content. A container may be configured for access to a group of users (e.g., viewers) of a particular program or OTT provider. For example, a bubble could be created for each distinct program for which UGC is content is desired.

Once UGC is aggregated in a container, content system 106 may provide one or more GUIs for managing UGC in one or more containers. Examples of GUIs for managing containers are described with reference to FIG. 4. The GUIs may enable a user of an OTT provider to manage (e.g., create, read, update, and delete) UGC. The UGC may be curated by an editor using the GUI. The editor can previews the UGC, looking at both the content of the UGC and the metadata of the UGC and then makes some decisions on what to do with the UGC. These decisions are assisted by a variety of algorithms that examine the content and metadata of the received UGC, and use this analysis to provide a broadcast-worthiness score for each UGC to the human editor. For example, producers of an OTT program can review UGC to determine as it's coming in and make decisions on which UGC they like, which media they would like to approve, and where would they like to approve it for. A user can approve or deny UGC for for digital distribution via an OTT provider system. Content system 106 may provide an application (e.g., a widget or an agent) to an OTT provider. UGC content may be communicated to an OTT provider via the application. UGC approved for presentation can goes into the appropriate application provided by the OTT provider. UGC manager 1524 may utilize an adaptor for an OTT provider to communicate UGC for a program to an OTT provider. The OTT provider can display UGC in the same or a different application providing the program.

Content system 106 provides UGC to OTT provider systems using one or more communication techniques for pulling, pushing, or both. OTT provider systems can request (“pull”) for UGC content in one or more containers. Content system 106 can send (“push”) UGC content to OTT providers. UGC content may be communicated to an OTT provider as it is received from a client system and/or according to one or more criteria (e.g., a schedule). In some embodiments, metadata for UGC may be provider with the UGC communicated to an OTT provider. UGC may be formatted according to a specification of an OTT provider. In some embodiments, a portion of different UGC in a container may be provided to an OTT provider based on one or more criteria. The criteria may be defined based on time, content, schedule, user, or any other information determinable from metadata. For example, UGC content can be distributed to an OTT provider based on when the UGC was obtained. In this example, UGC obtained during a particular time period (e.g., presentation of a program) can be provided so that users watching the program can view UGC provided by a user during the program.

An OTT provider system adaptor 1522 of content system 106 may provide UGC to an OTT provider according to one or more techniques. An adaptor 1522 may provide UGC based on a type of connection between the content system 106 and an OTT provider system. UGC may be provided in one or more blocks. UGC may be downscaled, compressed, and/or split into one or more blocks of the same or varying sizes. In some embodiments, an adaptor 1522 establishes one or more connections to an OTT provider system to communicate UGC. An adaptor 1522 may determine how to process UGC (e.g., size of blocks, number of blocks, or format of blocks), how many connections to open, how to handle connections that fail, what protocols to use for these connections, or combinations thereof. An adaptor 1522 may implement techniques for parallel processing for delivery of blocks of data defining UGC. Adaptor 1522 may be implemented to handle errors and challenges during communication of UGC. For example, adaptor 1522 may implement one or more techniques for retry and/or recovery of errors during communication of UGC. In some embodiments, content system 106 may include or communicate with a content distribution network (CDN) for communication of UGC. The CDN may be implemented to reduce a distance and time for communication of UGC to ensure real-time communication and management of UGC. In some embodiments, an adaptor 1522 may monitoring the speed of connections for communication of UGC. As each block of data for UGC gets uploaded, the adaptor 1522 may monitor how long it took to upload and add one or more parallel threads for communication on subsequent uploads. Threads may be added so long as the overall rate of communication is good. The number of threads may be adjusted based on a threshold for assessing a rate of communication.

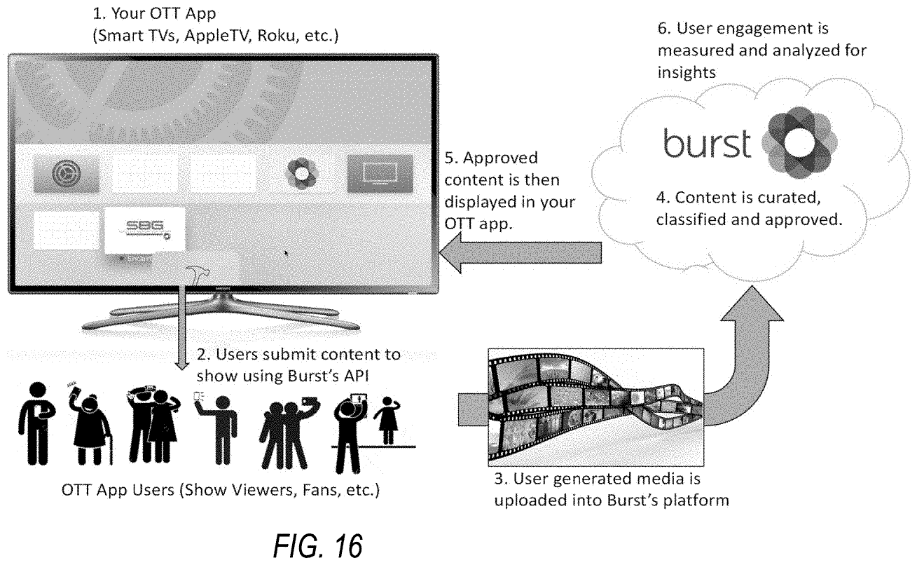

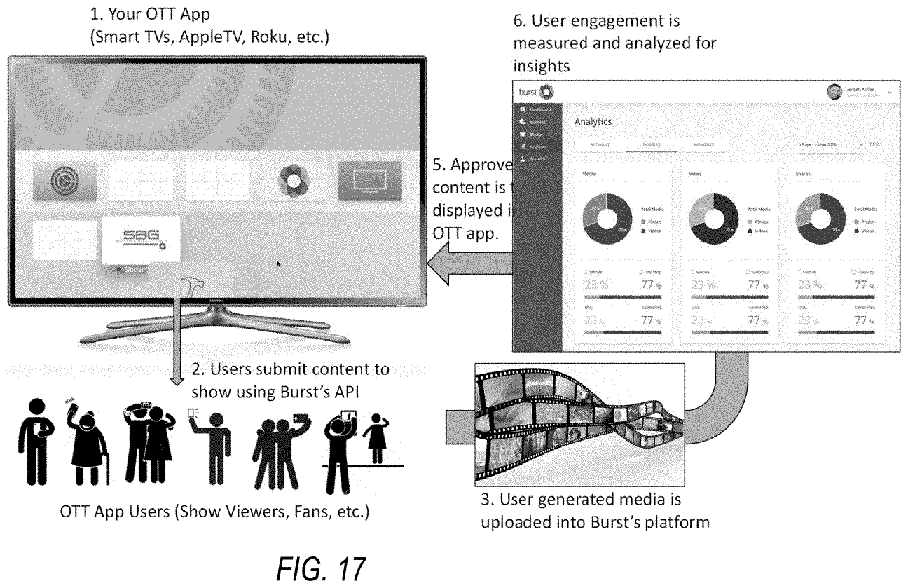

FIGS. 16 and 17 illustrate examples of system 1500 showing how content system 106 can facilitate capture and distribution of UGC from a client system to an OTT provider system. A user (e.g., show viewers, fans, etc.) operating one client system (e.g., a first client system), such as a media device, may interact with an application (“OTT app”) on the client system to provide UGC. The application may be integrated with or part of an application by an OTT provider during presentation of a program. The application may be provided by content system 106 and/or the OTT provider. Interaction with the application may cause data (e.g., a URL or a QR code) to be displayed at the first client system and/or presented in another application or communication accessible on another client system (e.g., a second client system). The data may be generated by content system 106 and provided to the OTT provider system.

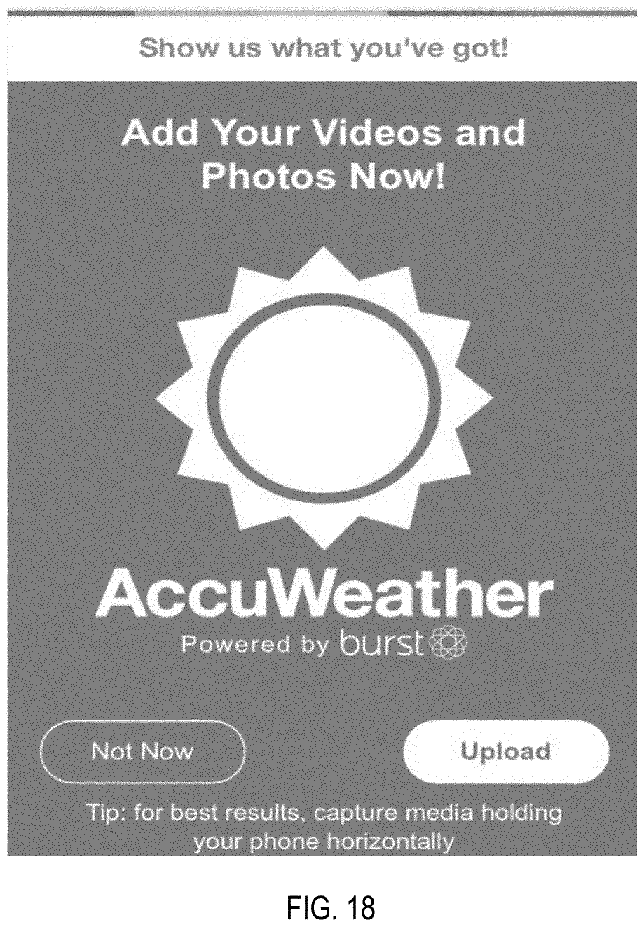

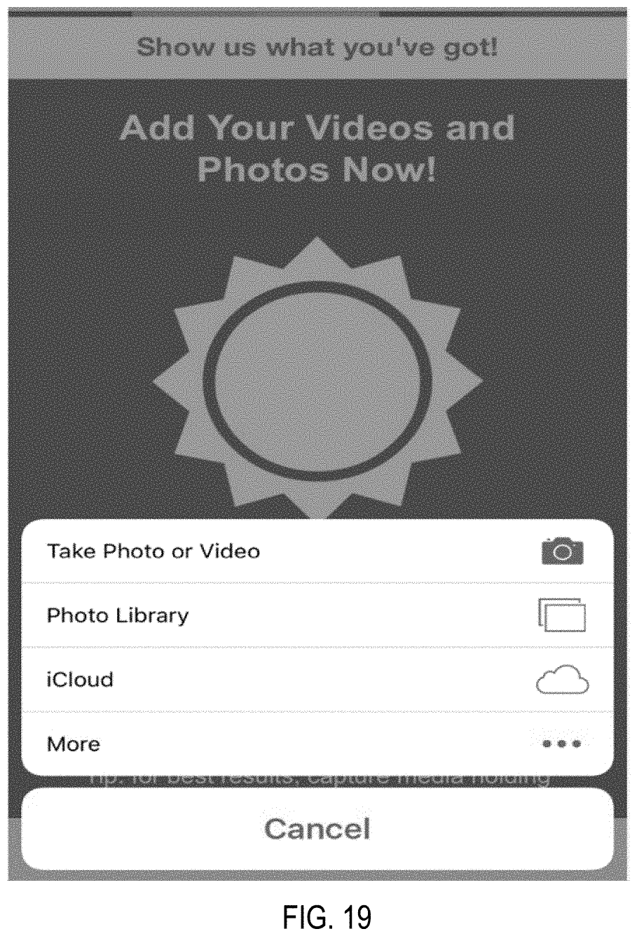

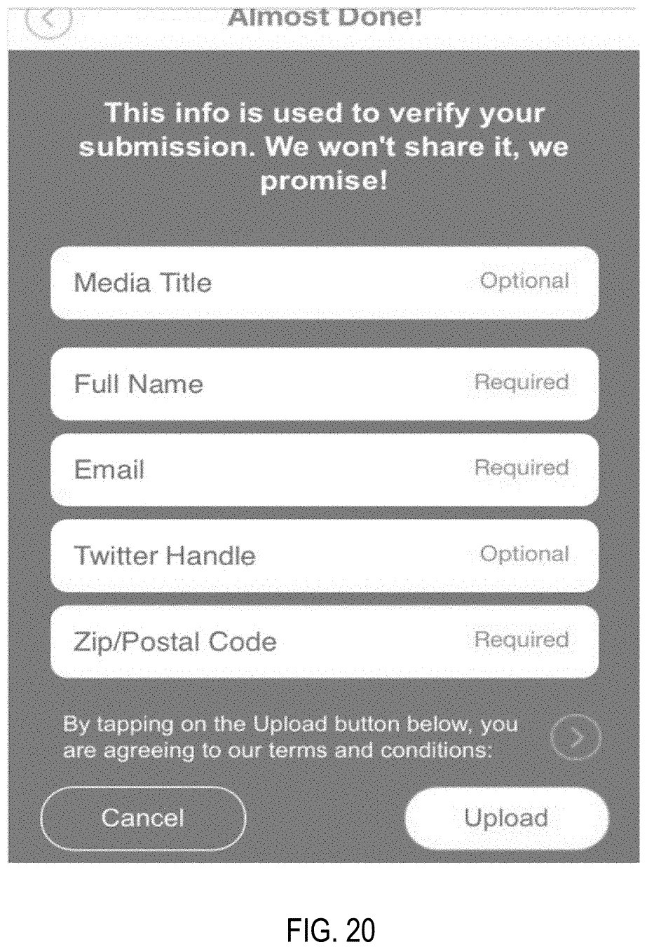

The user may operate the second client system to capture UGC before, during, or after interaction with the application on the first client system. After UGC is captured, the user may operate an application on the second client system to provide the data in the application to initiate a process for providing the UGC to the content system. An example of the application is a browser shown in FIGS. 18-20 that enables a user to upload UGC without having to download an application on the second client system. Upon providing the data to the application, the application may provide a series of GUIs to receive information about UGC stored on the second client system.

The application may access the UGC on the second client system and upload to content system 106 for content management. The content system 106 may enable a user (e.g., an editor) of the OTT provider system to curate, classify, and/or approve the UGC for distribution by the OTT provider system. The content system 106 distributes the approved UGC to the OTT provider system providing the program in the OTT app. The UGC received from the content system 106 can be displayed in the OTT app of the program to enable other users operating different client systems to view the UGC, in real-time, with the program.

In some embodiments, the content system 106 may monitor, measure, and analyze user engagement for providing UGC during any given program. The content system 106 may assess the UGC uploaded and distributed to OTT provider systems to determine user engagement and statistics for users uploading UGC with respect to programs. In some embodiments, the content system 106 may provide one or more GUIs (e.g., shown in step 6) of FIGS. 16 and 17.

FIGS. 18-20 illustrate GUIs that are presented on a client system to enable a user to upload UGC to the content system. The GUI in FIG. 16 may be presented in response to providing data (e.g., URL or QR code) in the application to content system 106. A user may interact with the GUI to initiate an upload process. FIG. 17 illustrates a GUI that enables a user to specify a source on a client system or to operate the client system to capture UGC. FIG. 18 illustrates a GUI that enables the user to provide information about the UGC to be included with the upload. The information can be viewed by a user for curation and for determination of the UGC to include in distribution to an OTT provider system.

Although specific embodiments of the present disclosure have been described, various modifications, alterations, alternative constructions, and equivalents are also encompassed within the scope of the present disclosure. The modifications include any relevant combination of the disclosed features. Embodiments of the present disclosure are not restricted to operation within certain specific data processing environments, but are free to operate within a plurality of data processing environments. Additionally, although embodiments of the present disclosure have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments of the present disclosure have been described using a particular combination of hardware and software, it should be recognized that other combinations of hardware and software are also within the scope of the present disclosure.

Embodiments of the present disclosure may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

1. A method for obtaining and distributing user-generated content (UGC) to content providers providing Over-The-Top OTT video content over the Internet, comprising:
providing a content Uniform Resource Locator (URL) in the OTT video content from an OTT content provider, the content URL being linked to a container associated with the OTT video content;
storing the container on a server of a content system;
receiving, in the container, via the content URL, UGC from a plurality of user devices of a plurality of users;
providing, to the OTT content provider, access to the UGC in the container;
distributing the UGC to the OTT content provider to enable display of the UGC;
providing an interface that enables the plurality of users to communicate the UGC from the user devices, in real-time, to the OTT content provider; and
incorporating, by the OTT content provider, at least some of the UGC into the OTT video content, in real-time during the presentation of the OTT video content.

2. The method of claim 1 further comprising:
including a link image in the OTT video content;
scanning the link image by the user device; and
enabling the interface in response to the link image.

3. The method of claim 1 wherein a graphical user interface (GUI) for the content system is presented in response to activation of the content URL.

4. The method of claim 1 wherein access to the UGC provided to the OTT content provider is provided through an API in a format customized for the OTT content provider.

5. The method of claim 1 wherein the content URL is obtained by the user device via a social media application.

6. The method of claim 5 wherein the OTT video content is gaming content.

7. The method of claim 1 further comprising:
including a Quick Response (QR) code in the OTT video content, the QR code containing the content URL linked to the OTT video content;
scanning the QR code by the user device;
extracting the content URL from the QR code;
providing a graphical user interface (GUI) for the content system in response to activation of the content URL; and
accessing the content URL to upload the UGC as related to the OTT video content.

8. The method of claim 1 further comprising:
accessing the content URL in response to the user operating a camera of the user device to capture an image that is configured with the content URL;
processing the image with the user device to cause the content URL to be accessed in an application on the user device; and
displaying a graphical user interface to upload the UGC to the container.

9. The method of claim 1 further comprising:
curating the UGC by the OTT content provider, including montage creation; and
approving the UGC by the OTT content provider.

10. A method for obtaining and distributing user-generated content (UGC) to content providers providing Over-The-Top (OTT) video content over the Internet, comprising:
streaming the OTT video content;
including a Quick Response (QR) code image in the OTT video content, the QR code image encoding a content Uniform Resource Locator (URL) in the OTT video content from an OTT content provider, the content URL being linked to a container associated with the OTT video content;
storing the container on a server of a content system;
scanning the QR code image with a plurality of user devices of a plurality of users;
decoding the content URL from the QR code image;
capturing the UGC from the plurality of user devices;
accessing the content URL to upload the UGC at an interface at the content URL that enables the plurality of users to communicate the UGC from the user devices, in real-time, to the content system, the accessing including accessing the content URL in response to the plurality of users operating a camera of the user devices to capture the QR code image that is configured with the content URL:
processing the QR code image with the user devices to cause the content URL to be accessed in an application on the user devices; and
displaying a graphical user interface to upload the UGC to the container;
receiving, in the container, via the content URL, the UGC from the user devices of the plurality of users;
providing, to the OTT content provider, access to the UGC in the container, wherein access to the UGC provided to the OTT video content provider is provided through an API in a broadcast format customized for OTT content provider;
curating the UGC by the OTT content provider;
approving the UGC by the OTT content provider; and
incorporating, by the OTT content provider, curated UGC into the OTT video content, in real-time during the presentation of the OTT video content.

11. A system for obtaining and distributing user-generated content (UGC) to a content provider providing Over-The-Top (OTT) video content over the Internet, comprising:
a plurality of user devices of a plurality of users;
a user device processor in each of the user devices;
a user device memory in each of the user devices;
non-transitory computer readable media in each user device memory, storing code that causes each user device processor to execute instructions to
capture UGC generated by each user device, and
upload the UGC;
an OTT content server;
an OTT content processor in the OTT content server;
an OTT content memory storing a container;
non-transitory computer readable media storing code that causes the OTT content processor to execute instructions to:
provide an interface that enables the plurality of users to upload the UGC from the user devices, in real-time, to the content provider;
receive the uploaded UGC, and
provide the UGC to the OTT video content provider for incorporation of the UGC into the OTT video content, in real-time during the presentation of the OTT video content:
an OTT content provider server;
an OTT content provider processor in the OTT content provider server;
an OTT content provider memory;
non-transitory computer readable media storing code that causes the OTT content provider processor to execute instructions to:
provide a content Uniform Resource Locator (URL) in the OTT video content from the OTT content provider, the content URL being linked to the container and associated with the OTT video content.

12. The system of claim 11 wherein the non-transitory computer readable media in the user device memory stores code that causes the user device processor to execute instructions to:
include a Quick Response (QR) code image containing the content URL in the OTT video content;
scan a QR code image in the OTT video content; and
enable the interface in response to the QR code image.

13. The system of claim 12 wherein a graphical user interface (GUI) for the content server is presented in response to activation of the content URL.

14. The system of claim 12 wherein access to the UGC provided to the OTT content provider is provided through an API in a broadcast format customized for the OTT content provider.

15. The system of claim 12 wherein the content URL is obtained by the user device via a social media application.

16. The system of claim 11 wherein the OTT video content is gaming content.

17. The system of claim 11 further comprising:
non-transitory computer readable media storing code that causes the OTT content processor to execute instructions to include a Quick Response (QR) code in the OTT video content, the QR code containing the content URL linked to the OTT video content;
non-transitory computer readable media in the user device memory, storing code that causes the user device processor to execute instructions to:
scan the QR code by the user device;
extract the content URL from the QR code;
provide a GUI for the content server in response to activation of the content URL; and
access the content URL to upload the UGC as related to the OTT video content.

18. The system of claim 11 further comprising:
non-transitory computer readable media storing code that causes the OTT content processor to execute instructions to:
access the content URL in response to the user operating a camera of the user device to capture an image that is configured with the content URL;
process the image with the user device to cause the URL to be accessed in an application on the user device; and
display a graphical user interface to upload the UGC to the container.

19. The system of claim 11 further comprising:
non-transitory computer readable media storing code that causes a content provider processor to execute instructions to:
curate the UGC by the OTT content provider; and
approve the UGC by the OTT content provider.

20. The system of claim 11
wherein a graphical user interface (GUI) for the content server is presented in a web browser application on the user device in response to activation of the content URL.
